(19) United States
(12) Patent Application Publication
(10) Pub. No.: US 2026/0058047 A1
(43) Pub. Date: Feb. 26, 2026

(54) COIL DEVICE

(71) Applicant: SUMITOMO ELECTRIC PRINTED CIRCUITS, INC., Shiga (JP)

(72) Inventor: Masaki MIYABARA, Shiga (JP)

(73) Assignee: SUMITOMO ELECTRIC PRINTED CIRCUITS, INC., Shiga (JP)

(21) Appl. No.: 19/302,213

(22) Filed: Aug. 18, 2025

(30) Foreign Application Priority Data
Aug. 21, 2024 (JP) 2024-139652

(51) Int. Cl. H01F 27/28; H01F 27/29

(52) U.S. Cl. CPC H01F 27/2828; H01F 27/292

(57) ABSTRACT

A coil device includes: a base film; a first wire; and a second wire. The base film has a first main surface and a second main surface. The first wire has a first wound portion disposed on the first main surface and a second wound portion disposed on the second main surface, each of the first wound portion and the second wound portion being a portion where the first wire is wound spirally in a plan view. The second wire has a third wound portion disposed on the first main surface and a fourth wound portion disposed on the second main surface, each of the third wound portion and the fourth wound portion being a portion where the second wire is wound spirally in a plan view.

### TECHNICAL FIELD

The present disclosure relates to a coil device. The present application claims priority based on Japanese Patent Application No. 2024-139652 filed on August 21, 2024. The entire contents of the Japanese Patent Application are incorporated herein by reference.

### BACKGROUND

For example, Japanese Patent Laying-Open No. 2021-68828 (PTL 1) describes a coil device. The coil device described in PTL 1 has a substrate, and a first wound portion, a second wound portion, a third wound portion, and a fourth wound portion.

The substrate has a first main surface and a second main surface opposite to the first main surface. The first wound portion and the second wound portion are disposed on the first main surface. The third wound portion and the fourth wound portion are disposed on the second main surface. In each of the first wound portion, the second wound portion, the third wound portion, and the fourth wound portion, a wire is wound spirally in a plan view. The wire that forms the first wound portion is disposed alternately with the wire that forms the second wound portion in a direction from an inner circumference to an outer circumference of the first wound portion. The wire that forms the third wound portion is disposed alternately with the wire that forms the fourth wound portion in a direction from an inner circumference to an outer circumference of the third wound portion. An innermost circumference of the first wound portion is electrically connected to an innermost circumference of the third wound portion and an innermost circumference of the second wound portion is electrically connected to an innermost circumference of the fourth wound portion.

### SUMMARY

A coil device according to the present disclosure includes: a base film; a first wire; and a second wire. The base film has a first main surface and a second main surface. The first wire has a first wound portion disposed on the first main surface and a second wound portion disposed on the second main surface, each of the first wound portion and the second wound portion being a portion where the first wire is wound spirally in a plan view. The second wire has a third wound portion disposed on the first main surface and a fourth wound portion disposed on the second main surface, each of the third wound portion and the fourth wound portion being a portion where the second wire is wound spirally in a plan view. A portion of the first wire in the first wound portion is disposed alternately with a portion of the second wire in the third wound portion in a direction from an inner circumference to an outer circumference of the first wound portion, and overlaps a portion of the second wire in the fourth wound portion in a plan view. A portion of the first wire in the second wound portion is disposed alternately with a portion of the second wire in the fourth wound portion in a direction from an inner circumference to an outer circumference of the second wound portion, and overlaps a portion of the second wire in the third wound portion in a plan view.

### BRIEF DESCRIPTION OF THE DRAWINGS

FIG. 1 is a first plan view of a coil device 100.

FIG. 2 is a second plan view of coil device 100 as seen from a direction opposite to that in FIG. 1.

FIG. 3 is a cross-sectional view taken along III-III in FIG. 1.

FIG. 4 is a diagram of a process for manufacturing coil device 100.

FIG. 5 is an explanatory diagram of a preparation step S1.

FIG. 6 is an explanatory diagram of an electroless plating step S3.

FIG. 7 is an explanatory diagram of a resist pattern forming step S4.

FIG. 8 is an explanatory diagram of an electrolytic plating step S5.

FIG. 9 is an explanatory diagram of a resist pattern removing step S6.

FIG. 10 is a first plan view of a coil device 200.

FIG. 11 is a second plan view of coil device 200 as seen from a direction opposite to that in FIG. 10.

FIG. 12 is a cross-sectional view taken along XII-XII in FIG. 10.

FIG. 13 is a first plan view of a coil device 300.

FIG. 14 is a second plan view of coil device 300 as seen from a direction opposite to that in FIG. 13.

FIG. 15 is a cross-sectional view taken along XV-XV in FIG. 13.

FIG. 16 is a graph showing a relationship between a transmission loss in a differential mode and a frequency in each of coil device 100 and coil device 300.

FIG. 17 is a graph showing a relationship between a transmission loss in a common mode and a frequency in each of coil device 100 and coil device 300.

### DETAILED DESCRIPTION

There is room for improvement in inductance characteristics of the coil device described in PTL 1. The present disclosure provides a coil device with enhanced inductance characteristics. According to the coil device of the present disclosure, the inductance characteristics are enhanced.

First, an embodiment of the present disclosure will be listed and described.

(1) A coil device according to an embodiment includes: a base film; a first wire; and a second wire. The base film has a first main surface and a second main surface. The first wire has a first wound portion disposed on the first main surface and a second wound portion disposed on the second main surface, each of the first wound portion and the second wound portion being a portion where the first wire is wound spirally in a plan view. The second wire has a third wound portion disposed on the first main surface and a fourth wound portion disposed on the second main surface, each of the third wound portion and the fourth wound portion being a portion where the second wire is wound spirally in a plan view. A portion of the first wire in the first wound portion is disposed alternately with a portion of the second wire in the third wound portion in a direction from an inner circumference to an outer circumference of the first wound portion, and overlaps a portion of the second wire in the fourth wound portion in a plan view. A portion of the first wire in the second wound portion is disposed alternately with a portion of the second wire in the fourth wound portion in a direction from an inner circumference to an outer circumference of the second wound portion, and overlaps a portion of the second wire in the third wound portion in a plan view. According to the coil device in (1) above, inductance characteristics are enhanced.

(2) In the coil device in (1), the first wire may have a first external connection terminal and a first land that are disposed on the first main surface, and a second external connection terminal and a second land that are disposed on the second main surface. The first external connection terminal and the first land may be connected to an outermost circumference and an innermost circumference of the first wound portion, respectively. The second external connection terminal and the second land may be connected to an outermost circumference and an innermost circumference of the second wound portion, respectively. The first land and the second land may overlap each other in a plan view. The second wire may have a third external connection terminal and a third land that are disposed on the first main surface, and a fourth external connection terminal and a fourth land that are disposed on the second main surface. The third external connection terminal and the third land may be connected to an outermost circumference and an innermost circumference of the third wound portion, respectively. The fourth external connection terminal and the fourth land may be connected to an outermost circumference and an innermost circumference of the fourth wound portion, respectively. The third land and the fourth land may overlap each other in a plan view. According to the coil device in (2) above, a reduction in height can be achieved.

(3) In the coil device in (1) or (2), a distance between the portion of the first wire in the first wound portion and the portion of the second wire in the third wound portion that are adjacent to each other may be equal to or less than 20 m, and a distance between the portion of the first wire in the second wound portion and the portion of the second wire in the fourth wound portion that are adjacent to each other may be equal to or less than 20 m.

(4) In the coil device in (1) to (3), a width of the portion of the first wire in the first wound portion and a width of the portion of the first wire in the second wound portion may be equal to or less than 20 m. A width of the portion of the second wire in the third wound portion and a width of the portion of the second wire in the fourth wound portion may be equal to or less than 20 m.

Next, details of the embodiment of the present disclosure will be described with reference to the drawings. In the drawings below, the same or corresponding portions are denoted by the same reference characters and redundant description will not be repeated. A coil device according to the embodiment is referred to as a coil device 100.

### Configuration of Coil Device 100

A configuration of coil device 100 will be described below.

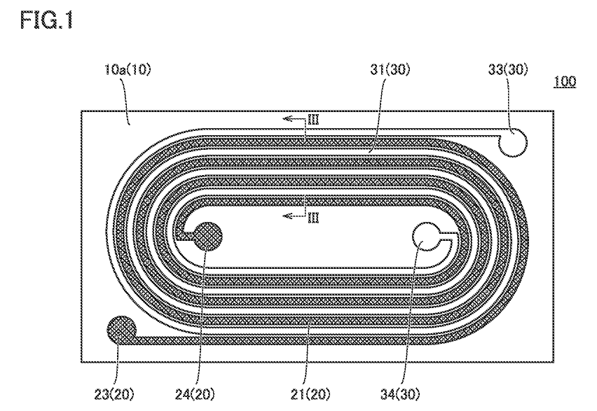

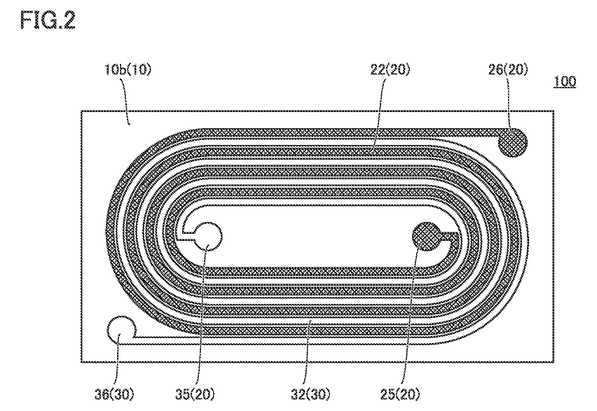

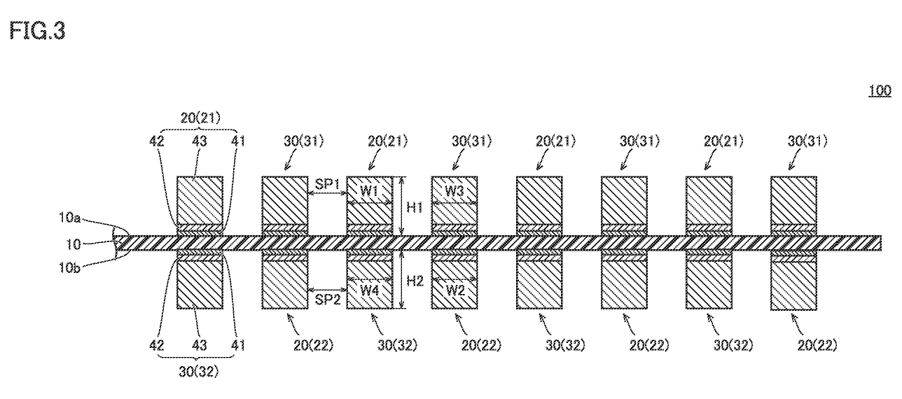

FIG. 1 is a first plan view of coil device 100. FIG. 2 is a second plan view of coil device 100 as seen from a direction opposite to that in FIG. 1. In FIGS. 1 and 2, a wire 20 is crosshatched in order to make a clear distinction between wire 20 and a wire 30. FIG. 3 is a cross-sectional view taken along III-III in FIG. 1. As shown in FIGS. 1, 2 and 3, coil device 100 has a base film 10, wire 20 and wire 30.

Base film 10 has a main surface 10a and a main surface 10b. Main surface 10b is a surface opposite to main surface 10a. Main surface 10a and main surface 10b are end faces in a thickness direction of base film 10. Base film 10 is made of, for example, a flexible electrically-insulating material. Specific examples of the constituent material of base film 10 include polyimide.

Wire 20 has a first wound portion 21 and a second wound portion 22. First wound portion 21 is disposed on main surface 10a. Second wound portion 22 is disposed on main surface 10b. In first wound portion 21, wire 20 is wound spirally in a plan view. In second wound portion 22, wire 20 is wound spirally in a plan view. “In a plan view” refers to a case in which coil device 100 is seen along a normal direction of main surface 10a or a normal direction of main surface 10b.

Wire 20 further has a first external connection terminal 23, a first land 24, a second land 25, and a second external connection terminal 26. First external connection terminal 23 is disposed on main surface 10a and is connected to an outermost circumference of first wound portion 21. First land 24 is disposed on main surface 10a and is connected to an innermost circumference of first wound portion 21. Second land 25 is disposed on main surface 10b and is disposed in an innermost circumference of second wound portion 22. Second external connection terminal 26 is disposed on main surface 10b and is disposed in an outermost circumference of second wound portion 22. First land 24 and second land 25 overlap each other in a plan view.

Wire 30 has a third wound portion 31 and a fourth wound portion 32. Third wound portion 31 is disposed on main surface 10a. Fourth wound portion 32 is disposed on main surface 10b. In third wound portion 31, wire 30 is wound spirally in a plan view. In fourth wound portion 32, wire 30 is wound spirally in a plan view.

Wire 30 further has a third external connection terminal 33, a third land 34, a fourth land 35, and a fourth external connection terminal 36. Third external connection terminal 33 is disposed on main surface 10a and is connected to an outermost circumference of third wound portion 31. Third land 34 is disposed on main surface 10a and is connected to an innermost circumference of third wound portion 31. Fourth land 35 is disposed on main surface 10b and is disposed in an innermost circumference of fourth wound portion 32. Fourth external connection terminal 36 is disposed on main surface 10b and is disposed in an outermost circumference of fourth wound portion 32. Third land 34 and fourth land 35 overlap each other in a plan view.

A portion of wire 20 in first wound portion 21 is disposed alternately with a portion of wire 30 in third wound portion 31 in a direction from an inner side to an outer side of first wound portion 21. The direction from the inner side to the outer side of first wound portion 21 refers to a direction perpendicular to a direction in which the portion of wire 20 in first wound portion 21 extends in a plan view. When the portion of wire 20 in first wound portion 21 extends in a curved manner in a plan view, the direction in which the portion of wire 20 in first wound portion 21 extends is defined as a tangent direction of the curved portion.

A portion of wire 20 in second wound portion 22 is disposed alternately with a portion of wire 30 in fourth wound portion 32 in a direction from an inner side to an outer side of second wound portion 22. The direction from the inner side to the outer side of second wound portion 22 refers to a direction perpendicular to a direction in which the portion of wire 20 in second wound portion 22 extends in a plan view. When the portion of wire 20 in second wound portion 22 extends in a curved manner in a plan view, the direction in which the portion of wire 20 in second wound portion 22 extends is defined as a tangent direction of the curved portion.

The portion of wire 20 in first wound portion 21 overlaps the portion of wire 30 in fourth wound portion 32 in a plan view. The portion of wire 20 in second wound portion 22 overlaps the portion of wire 30 in third wound portion 31 in a plan view. From another point of view, in the portion where wire 20 is wound spirally, wire 20 is disposed to face wire 30, not wire 20, with base film 10 interposed therebetween. This relationship of overlapping between wire 20 and wire 30 may only be satisfied at least in the portion where wire 20 and wire 30 extend linearly in a plan view.

A width of the portion of wire 20 in first wound portion 21 is denoted as a width W1. A width of the portion of wire 20 in second wound portion 22 is denoted as a width W2. A width of the portion of wire 30 in third wound portion 31 is denoted as a width W3. A width of the portion of wire 30 in fourth wound portion 32 is denoted as a width W4. Width W1 and width W3 are measured in the direction from the inner side to the outer side of first wound portion 21. Width W2 and width W4 are measured in the direction from the inner side to the outer side of second wound portion 22. Each of width W1 to width W4 is measured at arbitrary ten measurement points and is calculated as an average value of the measurement values at these ten measurement points.

A spacing between the portion of wire 20 in first wound portion 21 and wire 30 in third wound portion 31 that are adjacent to each other is denoted as a spacing SP1. A spacing between the portion of wire 20 in second wound portion 22 and wire 30 in fourth wound portion 32 that are adjacent to each other is denoted as a spacing SP2. Spacing SP1 is measured in the direction from the inner side to the outer side of first wound portion 21 and spacing SP2 is measured in the direction from the inner side to the outer side of second wound portion 22. Each of spacing SP1 and spacing SP2 is measured at arbitrary ten measurement points and is calculated as an average value of the measurement values at these ten measurement points.

A height of wire 20 is denoted as a height H1. A height of wire 30 is denoted as a height H2. Height H1 is a distance between the main surface of base film 10 and a top surface of wire 20 and height H2 is a distance between the main surface of base film 10 and a top surface of wire 30. Each of height H1 and height H2 is measured at arbitrary ten measurement points and is calculated as an average value of the measurement values at these ten measurement points.

Width W1 to width W4 are, for example, equal to or more than 4 μm and equal to or less than 20 μm. Spacing SP1 and spacing SP2 are, for example, equal to or more than 4 μm and equal to or less than 20 μm. Height H1 and height H2 are, for example, equal to or more than 4 μm and equal to or less than 50 μm.

Each of wire 20 and wire 30 has, for example, a seed layer 41, an electroless plating layer 42 and an electrolytic plating layer 43.

Seed layer 41 is disposed on the main surface (main surface 10a, main surface 10b) of base film 10. A constituent material of seed layer 41 is, for example, a nickel-chromium alloy. However, the constituent material of seed layer 41 is not limited thereto.

Electroless plating layer 42 is a layer formed by an electroless plating method. Electroless plating layer 42 is disposed on seed layer 41. Although not shown, base film 10 and seed layer 41 are provided with a first through hole and a second through hole. The first through hole overlaps first land 24 and second land 25 in a plan view. The second through hole overlaps third land 34 and fourth land 35 in a plan view. Electroless plating layer 42 is also formed on an inner wall surface of the first through hole and on an inner wall surface of the second through hole. Thus, first land 24 and second land 25 are electrically connected to each other and third land 34 and fourth land 35 are electrically connected to each other. A constituent material of electroless plating layer 42 is, for example, copper or a copper alloy. However, the constituent material of electroless plating layer 42 is not limited thereto.

Electrolytic plating layer 43 is a layer formed by an electrolytic plating method. Electrolytic plating layer 43 is disposed on electroless plating layer 42. A constituent material of electrolytic plating layer 43 is, for example, copper or a copper alloy. However, the constituent material of electrolytic plating layer 43 is not limited thereto.

### Method for Manufacturing Coil Device 100

A method for manufacturing coil device 100 will be described below.

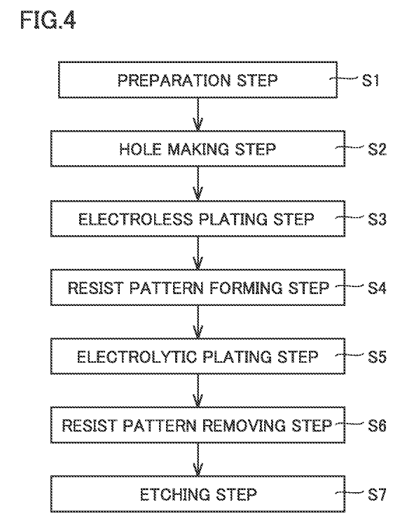

FIG. 4 is a diagram of a process for manufacturing coil device 100. As shown in FIG. 4, the method for manufacturing coil device 100 has a preparation step S1, a hole making step S2, an electroless plating step S3, a resist pattern forming step S4, an electrolytic plating step S5, a resist pattern removing step S6, and an etching step S7.

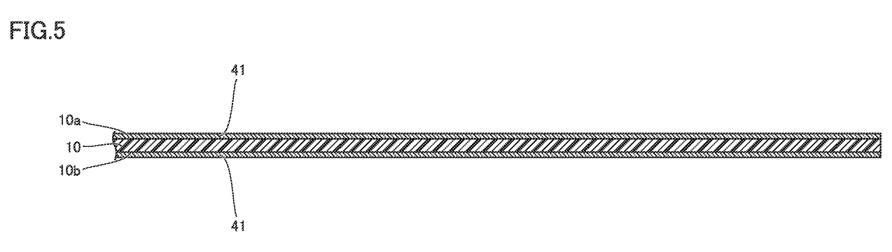

FIG. 5 is an explanatory diagram of preparation step S1. As shown in FIG. 5, in preparation step S1, base film 10 is prepared. Seed layers 41 are formed in advance on main surface 10a and on main surface 10b of base film 10 prepared in preparation step S1. After preparation step S1, hole making step S2 is performed.

In hole making step S2, the first through hole and the second through hole are formed in base film 10 and seed layer 41. The first through hole and the second through hole are formed by laser processing or drill processing, for example. After hole making step S2, electroless plating step S3 is performed.

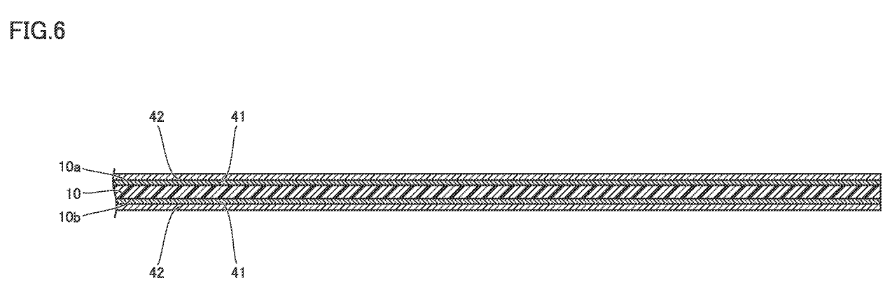

FIG. 6 is an explanatory diagram of electroless plating step S3. As shown in FIG. 6, in electroless plating step S3, electroless plating layer 42 is formed on seed layer 41 by the electroless plating method. Although not shown, electroless plating layer 42 is also formed on the inner wall surface of the first through hole and on the inner wall surface of the second through hole at this time. After electroless plating step S3, resist pattern forming step S4 is performed.

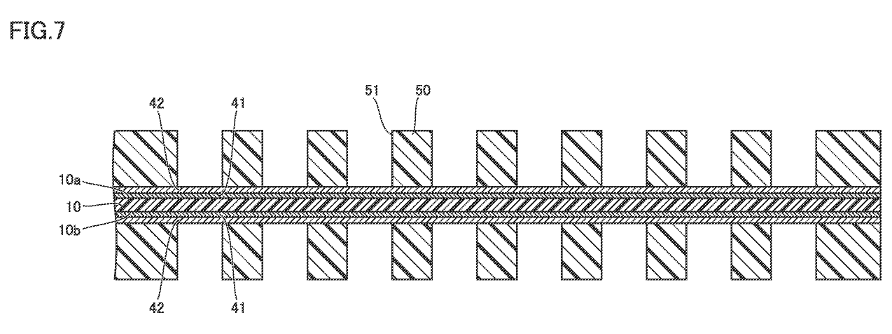

FIG. 7 is an explanatory diagram of resist pattern forming step S4. As shown in FIG. 7, in resist pattern forming step S4, a resist pattern 50 is formed on electroless plating layer 42. Resist pattern 50 has an opening 51. Electroless plating layer 42 is exposed from opening 51. Resist pattern 50 is formed by attaching a dry film resist onto electroless plating layer 42 and exposing the attached dry film resist to light and developing the attached dry film resist, for example. After resist pattern forming step S4, electrolytic plating step S5 is performed.

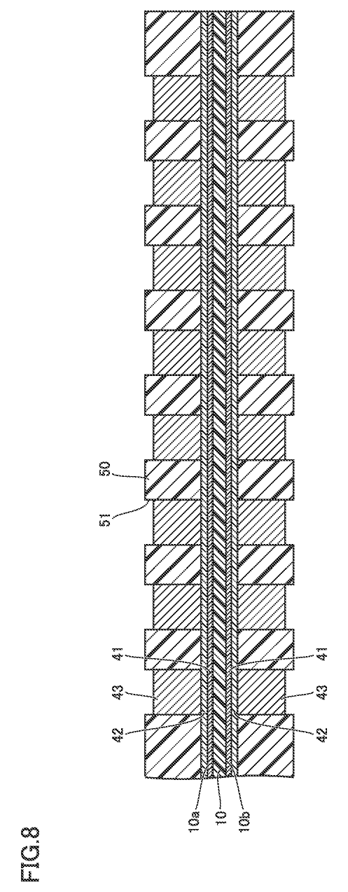

FIG. 8 is an explanatory diagram of electrolytic plating step S5. As shown in FIG. 8, in electrolytic plating step S5, electrolytic plating layer 43 is formed on a portion of electroless plating layer 42 exposed from opening 51 by the electrolytic plating method. After electrolytic plating step S5, resist pattern removing step S6 is performed.

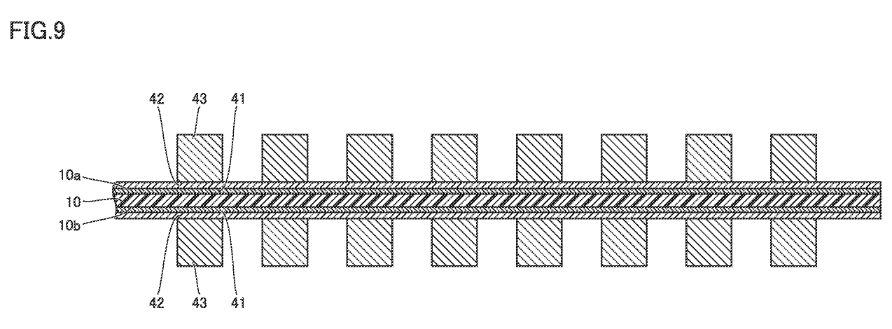

FIG. 9 is an explanatory diagram of resist pattern removing step S6. As shown in FIG. 9, in resist pattern removing step S6, resist pattern 50 is removed from electroless plating layer 42. After resist pattern removing step S6, etching step S7 is performed.

In etching step S7, the portion of electroless plating layer 42 and the portion of seed layer 41 that were located under resist pattern 50 before removal are removed by etching. In this way, in the method for manufacturing coil device 100, wire 20 and wire 30 are formed by a semi-additive method. A method for forming wire 20 and wire 30 is not limited thereto and wire 20 and wire 30 may be formed by a subtractive method, for example. As described above, the structure of coil device 100 shown in FIGS. 1 to 3 is formed.

### Effect of Coil Device 100

An effect of coil device 100 will be described below in comparison with coil devices according to comparative examples. A coil device according to a first comparative example is referred to as a coil device 200. A coil device according to a second comparative example is referred to as a coil device 300.

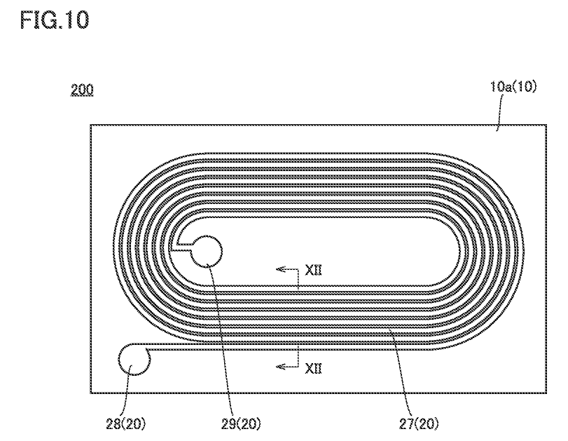

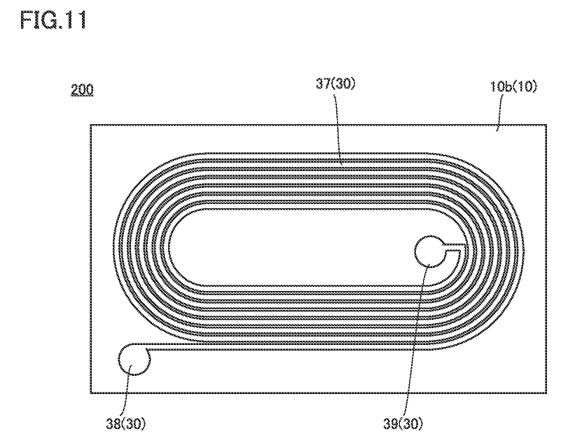

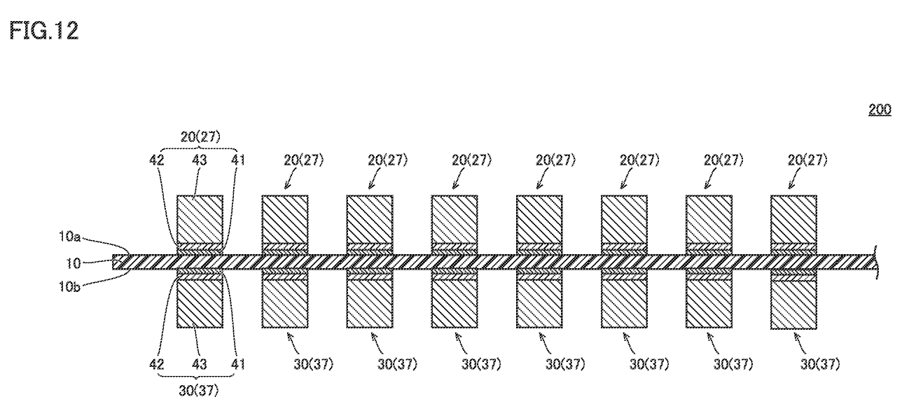

FIG. 10 is a first plan view of coil device 200. FIG. 11 is a second plan view of coil device 200 as seen from a direction opposite to that in FIG. 10. FIG. 12 is a cross-sectional view taken along XII-XII in FIG. 10. As shown in FIGS. 10, 11 and 12, coil device 200 has base film 10, wire 20 and wire 30. In this respect, the configuration of coil device 200 is the same as the configuration of coil device 100.

In coil device 200, wire 20 has a fifth wound portion 27, a fifth external connection terminal 28 and a sixth external connection terminal 29. Fifth wound portion 27, fifth external connection terminal 28 and sixth external connection terminal 29 are disposed on main surface 10a. In fifth wound portion 27, wire 20 is wound spirally in a plan view. Fifth external connection terminal 28 and sixth external connection terminal 29 are connected to an outermost circumference and an innermost circumference of fifth wound portion 27, respectively. The number of turns of wire 20 in fifth wound portion 27 is larger than the number of turns of wire 20 in first wound portion 21.

In coil device 200, wire 30 has a sixth wound portion 37, a seventh external connection terminal 38 and an eighth external connection terminal 39. Sixth wound portion 37, seventh external connection terminal 38 and eighth external connection terminal 39 are disposed on main surface 10b. In sixth wound portion 37, wire 30 is wound spirally in a plan view. Seventh external connection terminal 38 and eighth external connection terminal 39 are connected to an outermost circumference and an innermost circumference of sixth wound portion 37. The number of turns of wire 30 in sixth wound portion 37 is larger than the number of turns of wire 30 in third wound portion 31.

In coil device 200, a portion of wire 20 in fifth wound portion 27 overlaps a portion of wire 30 in sixth wound portion 37 in a plan view. From another point of view, in coil device 200, the portion of wire 20 in fifth wound portion 27 faces the portion of wire 30 in sixth wound portion 37 with base film 10 interposed therebetween. In these respects, the configuration of coil device 200 is different from the configuration of coil device 100.

In coil device 200, the number of turns of wire 20 and the number of turns of wire 30 that are equivalent to those of coil device 100 can be achieved with the same number of layers as that of coil device 100. However, in coil device 200, one (sixth external connection terminal 29) of the external connection terminals on main surface 10a and one (eighth external connection terminal 39) of the external connection terminals on main surface 10b are unavoidably disposed inside the wound portions.

Therefore, in coil device 200, an adhesive layer is disposed on main surface 10a (main surface 10b) to cover wire 20 (wire 30), a base film different from base film 10 is disposed on the adhesive layer, and an external connection terminal electrically connected to sixth external connection terminal 29 (eighth external connection terminal 39) is disposed on the base film. As a result, in coil device 200, coil device 200 has a great height.

In contrast, in coil device 100, first external connection terminal 23, second external connection terminal 26, third external connection terminal 33, and fourth external connection terminal 36 can be disposed outside the wound portions. Therefore, unlike coil device 200, a reduction in height of coil device 100 can be achieved.

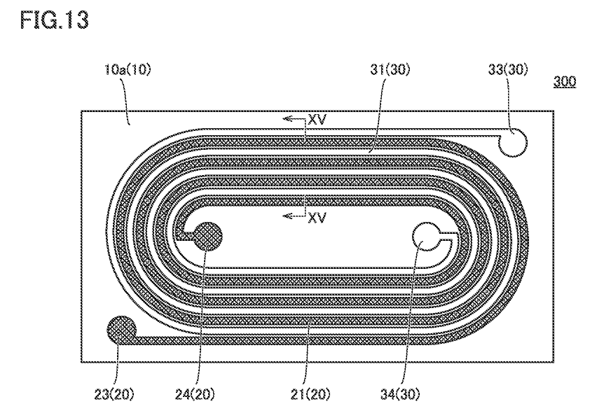

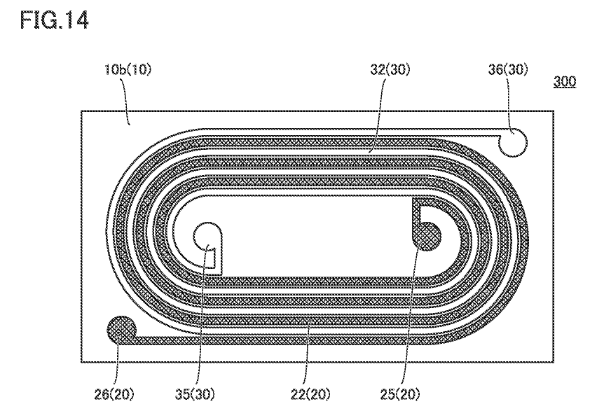

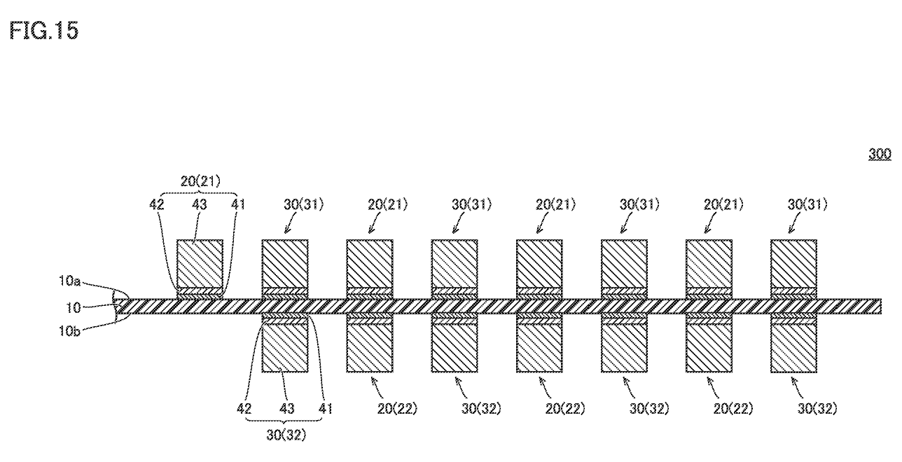

FIG. 13 is a first plan view of coil device 300. FIG. 14 is a second plan view of coil device 300 as seen from a direction opposite to that in FIG. 13. In FIGS. 13 and 14, wire 20 is crosshatched in order to make a clear distinction between wire 20 and wire 30. FIG. 15 is a cross-sectional view taken along XV-XV in FIG. 13. As shown in FIGS. 13, 14 and 15, coil device 300 has base film 10, wire 20 and wire 30. In this respect, the configuration of coil device 300 is the same as the configuration of coil device 100.

In coil device 300, the portion of wire 20 in first wound portion 21 overlaps the portion of wire 20 in second wound portion 22 in a plan view and the portion of wire 30 in third wound portion 31 overlaps the portion of wire 30 in fourth wound portion 32 in a plan view. In this respect, the configuration of coil device 300 is different from the configuration of coil device 100.

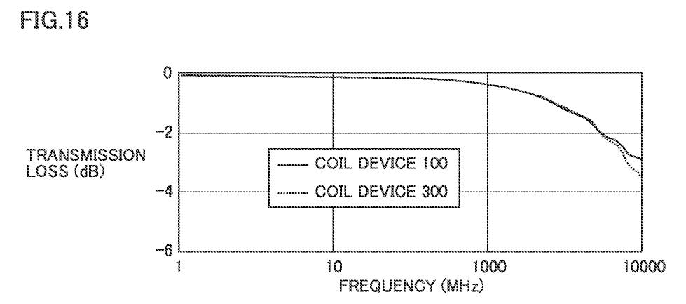

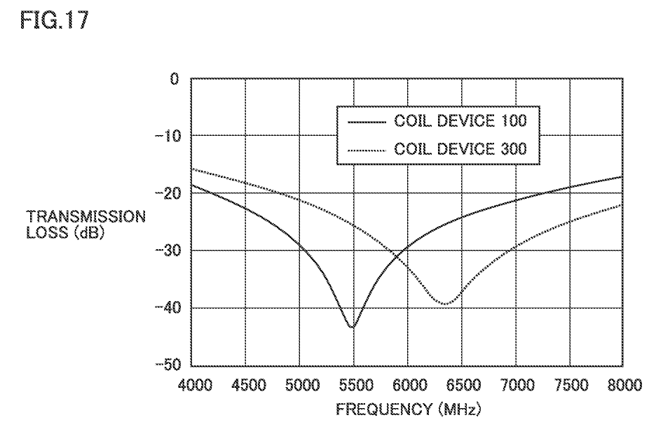

FIG. 16 is a graph showing a relationship between a transmission loss in a differential mode and a frequency in each of coil device 100 and coil device 300. FIG. 17 is a graph showing a relationship between a transmission loss in a common mode and a frequency in each of coil device 100 and coil device 300. The transmission loss in the differential mode refers to a transmission loss when AC signals of opposite phases flow through wire 20 and wire 30, and the transmission loss in the common mode refers to a transmission loss when AC signals of the same phase flow through wire 20 and wire 30.

As shown in FIGS. 16 and 17, the transmission loss in the differential mode in coil device 100 was smaller than the transmission loss in the differential mode in coil device 300. In addition, although both of the transmission loss in the common mode in coil device 100 and the transmission loss in the common mode in coil device 300 increased steeply at a specific frequency, the transmission loss in the common mode in coil device 100 changed more steeply. These comparison results show that according to coil device 100, i.e., with the configuration in which the portion of wire 20 in first wound portion 21 overlaps the portion of wire 30 in fourth wound portion 32 in a plan view and the portion of wire 20 in second wound portion 22 overlaps the portion of wire 30 in third wound portion 31 in a plan view, impedance characteristics are enhanced.

It should be understood that at least one of the configurations and features described in the embodiments and examples can be combined with another embodiment and example, or can be modified in various manner.

Although the embodiment of the present invention has been described, it should be understood that the embodiment disclosed herein is illustrative and non-restrictive in every respect. The scope of the present invention is defined by the terms of the claims, and is intended to include any modifications within the scope and meaning equivalent to the terms of the claims.

What is claimed is:

1. A coil device comprising:
a base film;
a first wire; and
a second wire, wherein
the base film has a first main surface and a second main surface,
the first wire has a first wound portion disposed on the first main surface and a second wound portion disposed on the second main surface, each of the first wound portion and the second wound portion being a portion where the first wire is wound spirally in a plan view,
the second wire has a third wound portion disposed on the first main surface and a fourth wound portion disposed on the second main surface, each of the third wound portion and the fourth wound portion being a portion where the second wire is wound spirally in a plan view,
a portion of the first wire in the first wound portion is disposed alternately with a portion of the second wire in the third wound portion in a direction from an inner circumference to an outer circumference of the first wound portion, and overlaps a portion of the second wire in the fourth wound portion in a plan view, and
a portion of the first wire in the second wound portion is disposed alternately with a portion of the second wire in the fourth wound portion in a direction from an inner circumference to an outer circumference of the second wound portion, and overlaps a portion of the second wire in the third wound portion in a plan view.

2. The coil device according to claim 1, wherein
the first wire has a first external connection terminal and a first land that are disposed on the first main surface, and a second external connection terminal and a second land that are disposed on the second main surface,
the first external connection terminal and the first land are connected to an outermost circumference and an innermost circumference of the first wound portion, respectively,
the second external connection terminal and the second land are connected to an outermost circumference and an innermost circumference of the second wound portion, respectively,
the first land and the second land overlap each other in a plan view,
the second wire has a third external connection terminal and a third land that are disposed on the first main surface, and a fourth external connection terminal and a fourth land that are disposed on the second main surface,
the third external connection terminal and the third land are connected to an outermost circumference and an innermost circumference of the third wound portion, respectively,
the fourth external connection terminal and the fourth land are connected to an outermost circumference and an innermost circumference of the fourth wound portion, respectively, and
the third land and the fourth land overlap each other in a plan view.

3. The coil device according to claim 1, wherein
a distance between the portion of the first wire in the first wound portion and the portion of the second wire in the third wound portion that are adjacent to each other is equal to or less than 20 m, and
a distance between the portion of the first wire in the second wound portion and the portion of the second wire in the fourth wound portion that are adjacent to each other is equal to or less than 20 m.

4. The coil device according to claim 1, wherein
a width of the portion of the first wire in the first wound portion and a width of the portion of the first wire in the second wound portion are equal to or less than 20 m, and
a width of the portion of the second wire in the third wound portion and a width of the portion of the second wire in the fourth wound portion are equal to or less than 20 m.
